(19) United States
(12) Patent Application Publication
(10) Pub. No.: US 2023/0334535 A1
(43) Pub. Date: Oct. 19, 2023

(54) COMPANY BALLOT AND METHOD FOR EVALUATING A COMPANY

(71) Applicant: Jacques Miles, Hummelstown, PA (US)

(72) Inventor: Jacques Miles, Hummelstown, PA (US)

(21) Appl. No.: 17/659,490

(22) Filed: Apr. 17, 2022

(51) Int. Cl. G06Q 30/02

(52) U.S. Cl. CPC G06Q 30/0282

(57) ABSTRACT

A ballot encompassing a ballot sheet and at least one object on the ballot in a section of the ballot sheet. One characteristic of the object is determined by a User ranking associated with an aspect of a company.

### CROSS REFERENCE TO RELATED APPLICATIONS

This application is filed under 35 U.S.C. 111(a) claiming benefit of U.S. Provisional Application No. 63/176,267 filed on Apr. 17, 2021. The entire contents of the application is incorporated herein by reference in their entirety.

### BACKGROUND

The modern economy is complex. It is becoming more and more difficult for employers to secure the “talent” they need when they need it. Talent referring to an employee(s) having the skills, education, certifications and similar desired by an employer for a role or role with said employer.

Also, it is becoming more and more difficult for aspiring employees including the next generation of employees (i.e., the middle and high school students today) to obtain fulfilling and secure employment. The situation could be improved if aspiring employees had access to more and better information when making a career decision(s).

Employers and those who desire employment with them need a better, more direct way to convey important information with each other; information that would be mutually beneficial to both parties. They can make better decisions regarding which companies to seek employment with and in which roles. They can make better decisions about which companies to invest in.

We developed an apparatus that helps employers and aspiring employees (current employees are not excluded) share information in a creative way and related methods. The apparatus reflects a person’s thoughts and feelings about various aspects of a specific business. Via our methodology, a User explores, analyzes, answers questions about and ranks certain aspects of a specific company in a systematic way. And the end result is a work of art, one of our Signature™ Ballots, which reflects the User’s thoughts and feeling about a company.

After a ballot is created, the ballot is submitted and stored in our system. Stored information like User rankings on submitted ballots is searchable and retrievable.

Via our methodology, one submitted ballot at a time, a User creates a great resource to guide her/his decision making process when she/he faces “company-centric” decisions in the future. More specifically, the resource can be used when the time comes to make important decisions that involve companies like what companies provide the best career opportunities for an individual; what companies should an individual invest in; etc.

Using our method, a User will develop business knowledge and become more business savvy while also realizing the known therapeutic benefits of creating art.

Today’s students, the next generation of employees and professionals, can benefit greatly from knowing more about companies. More knowledge about specific companies and business in general can help them successfully navigate their careers. Specifically, it can lead to better choices about occupations to pursue; industries to work in; and specific companies to work for or sell to if one chooses to be an entrepreneur.

Through our invention, we aim to bring about a world closer to the one we all should want. A world were companies have access to the talent they need to keep the economy growing. And a world with more professional opportunity for all. A world with more diversity and inclusion in all industries and occupations as well as less financial inequality.

### SUMMARY

In a non-limiting embodiment, the invention is a ballot including a ballot sheet and at least one object, a first object, wherein the color of the object is determined by a User’s answer to one or more questions provided with the ballot.

In a non-limiting embodiment, the present invention is a ballot including a ballot sheet having one or more sections and at least one doodle, a first doodle, in a section of the ballot sheet, wherein at least one characteristic of the first doodle is determined by a User ranking, a first User ranking.

In a non-limiting embodiment, the invention is a method for completing a ballot that includes providing a ballot sheet including at least one object; providing at least one question to be answered, a first question; providing instructions for how to translate the answer to said first question, a first answer, into a characteristic of the object; and receiving the ballot sheet.

### BRIEF DESCRIPTION OF THE DRAWINGS

FIG. 1. Shows a method of the present invention.

### DETAILED DESCRIPTION

The present invention encompasses a proprietary ballot, a Signature™ Ballot, and related methods.

In a non-limiting embodiment of the invention, the ballot of the invention is most closely associated with the result of a creative coloring exercise.

The ballot comprises a ballot sheet and at least one object, a first object on said ballot sheet, wherein the color of the object is determined by a User’s answer to one or more questions provided with the ballot.

In a non-limiting embodiment, the object comprises more than one section. The object can have one section, two sections, three sections, etc.

More than one object can be present. If more than one object is present on a ballot sheet, such can be referred to as a second object, a third object, etc.

The object can be a famous work of art by any artist like, for example, Leonardo Da Vinci’s Mona Lisa; Johannes Vermeer’s Girl with a Pearl Earring; Vincent van Gogh’s The Starry Night; Gustav Klimt’s The Kiss; Sandro Botticelli’s The Birth of Venus; Pablo Picasso’s Les Demoiselles d′Avignon; Edward Hopper’s Nighthawks; Andy Warhol’s MARILYN DIPTYCH; and many others.

The object can be an architectural structure or landmark like the White House; the Louvre; the Washington Monument; the Sears Tower; the Eifel Tower; the statue of Liberty; the Roman Colosseum; and many others.

The object can be any kind of automobile or boat or train or motorcycle or means of transportation. The object can be anything that can be colored.

To create/complete a ballot, a User will be provided various information about an employer on or outside the ballot itself. The information covers all of the information a potential employee applying for a role would or should be interested in knowing. Such includes, but is not limited to, the tasks an employee would be expected to perform in a given role; the pay for a role; the compensation and benefits for a given role; information about the size of the team; promotional and lateral opportunities available from a given role; the education, certification(s), skills and related required for a given role; the performance of the business which a role is in; and other similar information.

Such information can also concern a product and/or service of the employer. For example, where a product is sold; how much of a product is sold per year; what are the components of a product; and other relevant information.

A question(s) is also provided related the information provided about an employer. As an example, a question might be a yes or no question about whether some of the information provided about a role at an employer meets a User’s desires or expectations.

There can be one question, a first question, and other questions comprising a second, third, fourth, etc. question.

Instructions are provided so a User knows what action to take on a ballot based on his/her answers to one or more questions. For example, if the answer to a specific question is yes, the User is instructed to color at least a portion of the object on the ballot a certain color. That color may be red, black, blue, orange or any known color.

For example, if a User says “yes” to a salary for a role being acceptable, the User may be instructed to color a first section of an object the color blue. For example, if a User says “no” to a salary for a role being acceptable, the User may be instructed to color a first section of an object the color orange. Similarly, various instructions to color different sections of an object or different objects can be based on answers to different questions posed in a ballot.

Also, the answers to the questions in the ballot can be multiple choice answers. Various instructions to color different sections of an object or different objects can be based on answers to different multiple choice questions posed in a ballot.

Through the invention, A User can explore and evaluate various topics about an employer.

Examples of such topics include, but are not limited to, the following: jobs/careers at a company; the financial performance of a company over a period of time; the non-financial performance of company including its culture and community initiatives undertaken by the company; etc.

Herein, the terms “company”, “employer” and “business” are used interchangeably.

According to the present invention, the topics covered by a ballot can be broken down into aspects. Different ballots cover different topics and different aspects of a company. The aspects of a company are explored, evaluated and ranked. So a rankings is associated with most, if not all, aspects covered in a ballot.

When a User creates or completes a ballot, the User explores, evaluates, answers questions about and/or ranks various aspects of a company. For a first aspect of a company, there is a first User answer or ranking. For a second aspect of a company, there is a second User answer or ranking. For a third aspect of a company, there is a third User answer or ranking. For a fourth aspect of a company, there is a fourth User answer or ranking. And so on and so on like the previous. There can be an unlimited number of aspects of a company and a related number User answers or rankings.

A created or completed ballot is a work of art, literally, and reflects a User’s thoughts and feeling about the aspects of a company he/she explored, evaluated, answered questions about and/or ranked.

In a non-limiting embodiment of the invention, the ballot is most closely associated with a creative work of a drawing or painting. The present invention, a ballot comprises a ballot sheet having one or more sections or areas and at least one doodle or a scribble, at least a “first doodle”, in at least one section of the ballot sheet.

To help a User complete a ballot, one or more doodles or “creative prompts” based on a User ranking(s) are placed on the ballot sheet to get her/his creative juices flowing. Typically, a User completes a ballot sheet in accordance with a theme.

According to the present invention, a ballot comprises a ballot sheet having one or more sections or areas.

In a non-limiting embodiment, a ballot sheet can be blank, and instructions can be provided which allow a User to prepare the ballot sheet having one or more sections or areas.

In a non-limiting embodiment, a ballot sheet can include design and graphical elements.

According to the present invention, in order to complete a ballot, a User will need to determine one or more answers to questions or one or more rankings for one or more aspects of a specific company. The ratings correspond to the aspects of a company one would expect.

Non-limiting examples of aspects and related rankings are provided below.

Aspects of a company and associated rankings related to “Job Requirements and competition for a Job and workforce trends” can be expressed in various ways including, but not limited to, the following: what is your ability to compete for certain job?; (2) how competitive are you for a certain job?; and (e) what percent of people working in a certain role/job at a company will be more qualified than you? Aspects of a company and associated rankings related to “the duties associated with a certain job” can be expressed in various ways including, but not limited to, the following: (1) what is your ability to have success performing the required duties of the job and (2) what percent of people in this role will you outperform in your first year of employment?

Aspects of a company and associated rankings related to “Your Context” can be expressed in various ways including, but not limited to, the following: (1) How well will this role and/or career path meet your needs over the next 5 years?; (2) How competitive do you think this Career Path is as compared to others you might consider?; (3) For how many years, do you expect to be content on a specific career path?

Aspects of a company and associated rankings related to a “Local Area” can be expressed in various ways including, but not limited to, the following: (1) how attractive is the Local Area where a company is located to you?; (2) how does the local area where a company is located compare to other areas you may be considering moving to?

More exemplary, non-limiting rankings are proved below and labeled as R1 through R26.
R1- Your level of Interest in a Company and/or its Product(s) or Service(s);
R2- Your opinion of the Customer demand for a specified Product or Service;
R3- How interesting do you find the history of a company;
R4- Your ability to Compete for a specific Job;
R5- What percent of people in a role will be more qualified than you are when you are hired;
R6- Your ability to have Success Performing the required Duties of a Role;
R7- What percent of people in a Role will you outperform in Year X if you had the role;
R8- How well will a specified role and/or associated career path meet your needs over the next 5 years; R9- How competitive do you think a Career Path is as compared to others you may be considering; R10- What is your level of enthusiasm for living in an area where a company is located;
R11- What is your opinion about the level of opportunity in a specified Industry;
R12- What is your opinion on the level of competition to gain employment in a specified Industry;
R13- How do you rate the chances of becoming Wealthy pursuing a career in a specified industry;
R14- What rating would you give a company for managing its Expenses and/or Costs over a specified period of time;
R15- How would you describe the Extent of changes necessary for a specified company to effectively compete with its competitors;
R16- In your opinion, how good is a specified product or service of a company;
R17- How would you rate a company’s ability to increase or maximize its Revenue over a specified period of time;
R18- In your opinion, what is the extent of changes necessary at a company for it to effectively compete with its competitors;
R19- How good a job is a company doing to make the world a better place;
R20- How would you rank customer demand for a Product or Service sold by a specific company;
R21- How many other areas that you will consider working in are more/less attractive to work in than a specified local area?
R22- How confident are you that a specified company will exists in its current form for the next 5 years;
R23- Rank your level of Familiarity with a specified Company’s Products and/or Services;
R24- Rank the quality of a specified company’s products and/or services;
R25- Rank the qualifications of the leadership team of a specific company;
R26- Rank your level of enthusiasm for joining a specific company based on publicly available employee feedback;

In accordance with the present invention, User answers are expressed in various ways, as applicable, depending on the question(s) posed or asked in a ballot. User answers could be simple “yes” or “no” answers depending on the question. Or the answers could be any multiple choice answer suitable to answer a question.

In accordance with the present invention, User rankings are expressed in various ways, as applicable, depending on the aspect of a company being rated.

In a non-limiting embodiment, User Rankings can range from 1 to 5, or from 1 to 10, or 1 to 100 or other. A literal description of what a numerical ranking indicates or reflects is provided. There is no limitation on how User Rankings can be expressed.

In a non-limiting embodiment, User Rankings are not numerical. The actual User ranking just has to be reasonable and match up with the aspect of the company being ranked. Any suitable ranking system is encompassed by the present invention.

Examples of some of the ways rankings can be expressed are shown below. The “1 to 5” rankings provided below could have been reversed and expressed as “5 to 1” instead.

An example of suitable User rankings include:
1 = Very Poor
2 = Poor
3 = Average
4 = Good
5 = Great

Another example of suitable User rankings include:
1 = Strongly Disagree
2 = Disagree
3 = Neutral
4 = Agree
5 = Strongly Agree

Yet another example of suitable User rankings include:
1- Very uninteresting
2- Not interesting
3- Neither not interesting or interesting
4- Somewhat interesting
5- Very interesting

Another example of suitable User rankings include:
1- Thoroughly enjoy it
2- Enjoy it
3- Neither enjoy it or not enjoy it
4- Not enjoy it
5- Very much enjoy it

Yet another example of a suitable User rankings include:
1- Great financial shape
2- Good financial shape
3- Neither good or bad financial shape
4- Bad financial shape
5- Terrible financial shape

Another example of suitable User rankings include
1- Very much aligned
2- Aligned
3- Neither aligned or not aligned
4- Not aligned
5- Very much not aligned

Certain questions help a reasonable person evaluate an employer or relevant aspect of a company. In a non-limiting embodiment of the present invention, for each aspect of a business to be considered on a ballot, certain questions and other are provided.

In a non-limiting embodiment, the questions can help a User determine her/his User ranking for an aspect of the company.

The present invention comprises a means for providing questions in a ballot. In a non-limiting embodiment, the means for providing said questions can be a ballot questionnaire. A ballot questionnaire can be on a sheet or displayed on a computer or similar display device. Other suitable means for proving questions covered in a ballot are encompassed by the present invention. Exemplary, non-limiting questions that are suitable for the present invention including those below which are labeled as Q1 through Q95?

Q1. What is the best job at a specified company?

Q2: What is the best job for you at a specified company?

Q3. What do you want to be do to earn money?

Q4: Where- what company or city- would you prefer to work?

Q5. What is a company’s share of the market for one or more of its products or services?

Q6: Can you find an announcement(s) in the media about a new, big investment(s) in a new plant(s), a plant upgrade, an investment in new technology, and/or other.

Q7: Are there any unique challenges you would face at a specified company as a woman or a minority? Q8: Who is the highest ranking minority/woman at a specified company?

Q9: Can you find any news about a lawsuit or litigation involving a specific company over a certain period of time?

Q10: With specified profits and specified costs, how much can/should a company spend to buy another company? Or build a new plant?

Q11: What are ways a specified company can reduce its costs?

Q12: What are Key performance indicators for a specific business- the most important and/or the least important?

Q13: Has a specified company paid any dividends over a specified period of time? And if so, what % of earnings were paid as a dividend? And how were the dividends financed?

Q14: In a specified role/job, who will you report to?

Q15: Will your pay in a specified role exceed your expenses?

Q16: In a specified role, what quality of life will you be able to enjoy?

Q18: In a specified role, how much money do you plan to save per month?

Q19: What is the maximum percentage of your pay will you spend on housing?

Q20: What are the names of 5 businesses in your local community?

Q21: What is the largest (in terms of revenue or number of employees) company in your community?

Q22: How does a specified company compare to another specified company in terms of revenue, expenses, number employees, and/or other?

Q23: What is the name of a product or service sold by a specified company?

Q24: Do any of a specified company’s competitors sell a similarly priced product or service?

Q25: What % of the competition for a specified role will have better credentials than you do?

Q26: Will you require more education to be competitive for a specified role?

Q27: Will you be required to work more or less hours in one specified role as compared to a second specified role?

Q28: How much more compensation do you expect to receive in a first specified role as compared to a second specified role?

Q29: Will you have to attend more or less meetings in a first specified role as compared to a second specified role?

Q30: Will you dress differently in a first specified role as compared to a second specified role?

Q31: Will you be able to schedule a meeting with the CEO in a specified role?

Q32: Will you have different priorities- in life and/or at work- in a first specified role as compared to a second specified role?

Q33: how is or will technology impact a specific job today or in the future?

Q34: If hired for a specific job/role, what do you envision will be your biggest accomplishment in your first week of employment?

Q35: What is the best thing about a specific job?

Q36: What is the worst thing about a specific job

Q37: What is the population of a city where a specific job is located?

Q38: What are the demographics of a city where a specific job is located?

Q39: What is the average home price in a city where a specific job is located?

Q40: What is the average price of an apartment rental in a city where a specific job is located?

Q41: What is the crime rate in a city where a specific job is located?

Q42: What is one of the most popular recreational site in a city where a specific job is located?

Q43: What is more important to you- Money or Power?

Q44: Do you want to have a child(ren) one day? If yes, how will having kids impact your need for revenue?

Q45: How many people does a specific company need on a specified Career Path? And Will the company need more or less people on said career path in the future?

Q46: What skills, experience, credentials will you need to get hired in a specified role?

Q47: What skills, experience, credentials and other will you need to advance in a specified role?

Q48: How often does a specified company perform performance reviews of employees people in a specific role?

Q49: How does a specific company conduct performance reviews?

Q50: At a specified company, how many people per year get put on Performance Improvement Plans?

Q51: When was a specific company founded?

Q52: Who founded a specific company?

Q53: In what city was a specific company founded?

Q54: Why was a specific company founded? What need was the company founded to meet and/or who were supposed to be the primary customers of the company?

Q55: For a specified company, what were the sales, in total or for a specific product or service, during a specified quarter?

Q56: How profitable are sales of a specified product for a specific company?

Q57: What percentage of sales of a specified product happened in a specific company over a specified period of time?

Q58: What is the top selling product of a specific company over a specified period of time?

Q59: What is a similar product or service to a specified product or service sold commercially? And what company sells the competitive product or service?

Q60: What are the Total expenses for a specific company over specified time period?

Q61. What are the total sales for a specific company over a specified time period?

Q62. For a specified company, did expenses increase or decrease over specified period?

Q63: For a specified company over a specified period of time, what was the expense for Marketing?

Q64: What were the Total revenues for a specified company over a specified time period?

Q65: For a specified company over a specific time period, did the revenues increase or decrease?

Q66: What was the revenue from a specified product or service over a specified period of time?

Q67: To increase company revenues, should a specified company create a new product or service?

Q68: If a specified company were to create a new product or service, what features or attributes should the new product or service have?

Q69: Should a specified company explore an acquisition or a divestiture?

Q70: If a specified company is interested in doing an acquisition, what characteristics should the company to be acquired have?

Q71: If a specified company is interested in doing a divestiture, what business should it sell?

Q72: Has a specific company bought back any of it stock in the past 3, 6, 12, etc. months?

The present invention also encompasses and includes questions related to Personal Finance. Some non-limiting examples are below:

Q73: Over a specified period of time, how much money have you made?

Q74: Over a specified period of time, how much money have you spent?

Q75: Over a specified period of time, how much money have you saved?

Q76: Over a specified period of time, how much debt have you accumulated?

Q77: Name a product or service you buy that is made by a specified company or one of its competitors?

Q78: What is your favorite business? in your local area?

Q79: What is your favorite product?

Q80: What is the name of the best run/managed business in the area where you live?

Q81: In your opinion, What business offers the best customer service?

Q82: What is the most profitable business in your area?

Q83: What business in your local area has the most diverse ownership?

Q84: How much money does your family spend per month total?

Q85: How much money does your family spend per month on- milk, electricity, transportation, food, entertainment and/or housing?

Other suitable questions directed to or related to Personal Finance are encompassed by this description of the invention.

The present invention also encompasses and includes questions related to Financial Literacy. Some non-limiting examples are below:

Q86: How much money should the average person dedicate to savings every month?

Q87: What are the 5 factors that add up to make a person’s credit score?

Q88: What’s the most income a person should use on monthly credit card payments?

Q89: What’s the maximum debt-to-income ratio a person should have to maintain financial stability?

Q90: How often can a person check her/his credit report for free?

Q91: How much money does a person need for a down payment on a traditional mortgage?

Q92: What does APR stand for?

Q93: How is net worth calculated?

Q94: What are the 3 C’s of credit worthiness?

Q95: What federal law protects a person’s rights from abusive collection tactics?

Other suitable questions directed to or related to financial literacy are encompassed by this description of the invention.

For a given question or questions, one or more Source Materials can be described or provided. The Source Material can be a resource or reference which can be used to find a suitable answer to a question(s). Source Material can be any publication, reference, etc. that can be used to provide a suitable answer(s) to one or more of the questions.

Examples of Source Material include, but is not limited to, the following:
S1: Linked In Profiles;
S2: Job Postings like on sites like Indeed, Monster.com;
S3: Company Webpages;
S4: Real Estate websites like Zillow, etc.;
S5: City and County websites;
S6: Employee review sites like Ladders and Glassdoor;
S7: Job related webpages like Glass Door, the Ladders, etc.; and
S8: Activist Investor Letters.

In a non-limiting embodiment of the invention, a link(s) to a Source Material(s) can be included along with the ballot sheet.

In a non-limiting embodiment, the present invention comprises a means for translating a ranking(s) or an answer(s) to a question(s) or other into a doodle on the ballot sheet. In one non-limiting embodiment, said means for translating a ranking or answer(s) to a question(s) or other into a doodle on the ballot sheet is a legend. The legend can be provided along with a ballot sheet or with a ballot questionnaire. The ballot sheet can be a sheet or displayed on a display screen like a computer screen or a cellphone screen or a tablet.

In a non-limiting embodiment, a custom legend is created by a User.

Suitable other means for translating a ranking or answer(s) to a question or other into a doodle on the ballot sheet is encompassed by the invention.

In a non-limiting embodiment, a ballot questionnaire, a legend and a ballot sheet can be included together in one document or displayed together. Or they can be on different documents or displayed separately.

According to the present invention, a doodle has its common definition. For example, a doodle can be referred to as a scribble.

A doodle can have one or more characteristics like a location on a ballot sheet, a shape, a size, a color, etc. Said characteristic(s) can be determined by one or more User answers or rankings.

In a non-limiting embodiment, a first, second and third characteristic of a doodle is determined by a first User answer or ranking. The first characteristic can be a location of the doodle on a ballot sheet. The second characteristic of a doodle can be the shape of the doodle. And the third characteristic of a doodle can be the color of the doodle.

In a non-limiting embodiment, a first characteristic of a doodle is determined by a first User answer or ranking and a second characteristic of the doodle is determined by a second User answer or ranking.

A doodle is a means for expressing a User’s thoughts and feelings about an aspect(s) of a company. As a result, a doodle comprises one or more of the following: colors, shapes, objects, colored objects and/or shapes.

In a non-limiting embodiment of the present invention, the placement of multiple doodles on the ballot sheet is determined by a User answer or ranking associated with an aspect of the company. For example, a first User answer or ranking determines the placement of a first doodle. For example, a second User answer or ranking determines the placement of a second doodle. For example, a third User answer or ranking determines the placement of a third doodle. And so on and so forth for an unlimited number of User answers or rankings and doodles.

Below are examples of when and how a User answer or ranking determines the placement of the doodle, a first doodle, for example, on a ballot sheet.

If “1” is the relevant User answer or rating, place the doodle anywhere in Section 3 of the Ballot Sheet, for example.

If “2” is the relevant User answer or rating, place the doodle anywhere in Section 1 of the Ballot Sheet, for example.

If “3” is the relevant User answer or rating, place the doodle anywhere in Section 6 of the Ballot Sheet, for example.

If “4” is the relevant User answer or rating, place an X in blue anywhere in Section 5 of the Ballot Sheet, for example.

In a non-limiting embodiment, the doodle is a colored line whereby the actual color of the line is derived from one or more of the User’s answers or rankings. In other words, the User answer or ranking determines the color of the line.

In a non-limiting embodiment, the doodle is a colored line which may be 0.5 inch, 1 inch, 1.5 inch, 5 inch, 8 inch. The line can be any length.

In a non-limiting embodiment, the doodle is an object whereby the actual object is derived from one or more of the User’s answers or ranking. In other words, a User answer or ranking(s) determines the specific object serving as a doodle.

In a non-limiting embodiment, the doodle(s) comprises one or more of the following:
1 star, 2 stars, 5 stars, 10 stars, 50 stars...
1 circle, 5 circles, 23 circles
1 triangle, 8 triangles, 18 triangles
3 horses, 5 horses, 29 horses,
1 fish, 10 fish, 40 fish
1 basketball, 7 basketballs, 100 basketballs
1 smiley face, 11 smiley faces, 34 smiley faces

In a further non-limiting embodiment, the object is colored, and the actual color of the object is derived from one or more of the User’s answers or rankings. In other words, a User ranking(s) determines the color of the object.

In a non-limiting embodiment, the doodle is a word(s) and/or a number(s).

According to the present invention, a doodle can be any shape, object and/or symbol in any amount. According to the present invention, a doodle can be drawn by hand.

According to the present invention, a doodle can be made using a stamp.

According to the present invention, a doodle can be made via a computer keystroke or program or other.

According to the present invention, a doodle can comprise a sticker(s).

In a non-limiting embodiment, a User can choose and describe his/her choice for the color of a doodle. In a non-limiting embodiment, the User can choose to make the doodle the color red to express anger or love.

In a non-limiting embodiment, the User can choose to make the doodle the color pink to express love or cheerfulness.

In a non-limiting embodiment, the User can choose to make the doodle the color blue to express sadness or calm.

In a non-limiting embodiment, the User can choose to make the doodle the color green to express good energy, soothing, calm and safety.

In a non-limiting embodiment, the User can choose to make the doodle the color yellow to express cheerfulness and good energy.

In a non-limiting embodiment, the User can choose to make the doodle the color orange to express happiness and healthy.

In a non-limiting embodiment, the User can choose to make the doodle the color purple to express sadness, disgust and mystery.

In a non-limiting embodiment, a doodle(s) can be the first marks on a ballot sheet upon which a User can build upon to create a work of art, decorative Signature™ ballot. As such, doodles can be creative prompts for a more expansive creative effort.

After a doodle(s) is placed on the Ballot Sheet, a User can expand upon the doodle(s) to create a personal work of art that reflects his/her thoughts and/or opinions of the aspects of the company he/she explored, evaluated and ranked in a ballot.

The description above about the doodle is non-limiting. Other descriptions of the doodle similar to those described above are encompassed by the present disclosure and fall under the described invention.

For the drawing impaired, a sticker or similar can be provided and used as the doodle. The Sticker can be colorable or capable of being colored. Again, the color of doodle can be determined by a relevant User ranking.

In a nonlimiting embodiment, a theme or themes to complete a ballot as a work of art is provided. Generally, a User will be instructed to beautify or complete the ballot in accordance with a theme. According to the present invention, a theme can be provided for ballot or be chosen by a User. Suitable, but not limiting themes for the invention, are provided below:
(a) The view out of your office window;
(b) Something you see on the way to work;
(c) An article of clothing;
(d) A tool used at work;
(e) Your dream vacation;
(f) Your favorite car;
(g) An item of sports memorabilia; and
(h) a magazine ad featuring a Company’s Products or services.

The above are only examples. The theme can be anything one can imagine. The present invention encompasses every possible theme.

As discussed above, a ballot can cover various topics. Below we describe aspects of a company that might be suitable to consider on a ballot depending on the topic(s) covered in the ballot. Also suitable rankings associated with an aspect of the company are provided.

An example ballot which covers at least the operational performance of company might explore the following aspects of a company: (1) Industry Trends; (2) Company Expenses; (3) Company Revenue; and (4) Progress on Corporate Initiatives.

Ratings that align with the “Industry Trends” aspect include: (1) Opportunity in the Industry; (2) the level of Competition in the Industry; and (3) Company Expenses.

Suitable questions to consider before ranking the “Opportunity in the Industry” include the following:

(a) is employment in the industry increasing or decreasing?

(b) is the Customer Base for the company increasing or decreasing?

(c) is the health of the company’s customers improving or getting worse?

(d) Does the industry the company is in have any new, relevant Industry wide initiatives?

Suitable questions to consider before ranking the “Competition in the Industry” include the following:

(a) Have any companies entered the industry the company is in? Or have any competitors left the industry the company is in?

(b) What is the chance to become Wealthy pursuing a career in the industry the company is in?

Ratings that align with the “Management of the Company’s Expenses/Costs” aspect include: (1) Opportunity in the Industry; and (2) Extent of changes necessary to effectively compete with competitors?

Suitable questions to consider before ranking the “Company’s Management of Expenses/Costs” include the following:

(a) Has the media reported on any recent layoffs? If yes, what roles have been cut?

(b) What does the company spend the most money on?

(c) What is the company’s Most expensive product to make?

Ratings that align with the “Company Revenue” aspect include: (1) level of Familiarity with the Company’s Products or Services; (2) the quality of a specific Product or service of the company is; (3) the Ability to Increase/Maximize Revenue; and (4) the Extent of changes necessary to effectively compete with competitors?

Suitable questions to consider before ranking the “level of Familiarity with the Company’s Products or Services” include the following:

(a) Has the company introduced any new products? Or has the company stopped selling any products?

(b) Does the company have any new customers? Or has the company lost any customers?

Ratings that align with the “Progress on Corporate Initiatives” aspect include: (1) How good a job is the company doing to make the world a better place?

Suitable questions to consider before ranking the “Level of Interest in the Company and its Product or Service” include the following:

(a) Why/when would you use this product?

(b) Have you ever used the product or know someone who has?

(c) What are the most important features/characteristics of the product?

(d) How much would you pay for the product?

Suitable questions to consider before ranking the “Customer demand for the Product or Service” include the following:

(a) How would you describe customers for this product?

(b) How many potential customers for the product reside in the USA? In another country?

(c) What product features do you think are most important to current customers?

Suitable questions to consider before ranking the “Ability to Compete for this Job” include the following:

(a) how many people will apply for a specified role?

(b) What percent of people applying are just as or more qualified than you are?

(c)What is the most important credential/qualification others applying for this job have that you do not have?

(d) For a role, what credential/qualification do you have that others do not have?

Suitable questions to consider before ranking the “Chance to have Success Performing the Duties” include the following:

(a) What duty required of the role will you enjoy the most?

(b) What duty required by the role will you enjoy the least?

(c) Will you be an exceptional performer in this role? And if so Why?

(d) How do you define a meaningful promotion from this role?

Suitable questions to consider before ranking the “How well with this role/path meet your needs over the next 5 years” include the following:

(a) How long before you will get bored with this job? Or how long will you work this job before receiving a meaningful promotion?

(b) Do you expect to have a kid(s) over a stated time period? Will that impact your expectations of the role/company?

(c) Will you want to acquire additional education while employed by this company? And if so, will the company be supportive of your educational plans?

(d) Will you want to run for elected office while employed by this company? If so, Will the company be supportive?

Suitable questions to consider before ranking the “Attractiveness of the Local Area” include the following:

(a) what is the Level of Unemployment in the City? State?

(b) what is the Level of Crime in the area?

(c) what Type of government does the area have?

(d) what are popular Entertainment options in the area?

(e) How many level 1 trauma centers are in the area?

(f) How many other areas that you will consider working in are more or less attractive to work in than this area?

Suitable questions to consider before ranking the “How good a job is the company doing to make the world a better place” include the following:

(a) Does the company have a Minority Purchasing program?

(b) is the company undertaking any initiatives related to LBGT?

(c) is the company undertaking any initiatives related to the environment or any green initiatives?

(d) How does the company impact the communities it is in?

(e) describe the company’s Lobbying activities? what laws and/or politicians has the company supported?

Below additional suitable, exemplary questions are shown for certain Rankings.

Exemplary questions for the “Level of Interest in the Company and its Product or Service” ranking include, but are not limited to, those below:

(a) Why/when would you use this product?

(b) Have you ever used the product or know someone who has?

(c) What are the most important features/characteristics of the product?

(d) How much would you pay for the product?

Exemplary questions for the “Customer demand for the Product or Service” ranking include, but are not limited to, those below:

(a) How would you describe the customers for this product?

(b) How many customers for the product reside in the USA?

(c ) What product features do you think are most important to current customers?

All of the questions contained herein can be presented in conjunction with a ranking and/or on its own, independent of any ranking(s).

An example ballot which covers a role(s) or a career(s) at company might explore the following aspects of a company: (1) Company History including Products and Services; (2) Job Requirements AND COMPETITION and Workforce Trends; (3) Duties [Questions related to Customers/Customer Service]; (4) Your Context; and (5) Local Area

Ratings that align with the “Company History including Products and Services” aspect include: (1) Level of Interest in the Company and its Product or Service; (2) Customer demand for the Product or Service; (3) How interesting is the history of this company based on what you know at this point?; and (4) How many more years do you expect this company to exists in its current form?

All of the ratings or rankings contained herein are exemplary. Similar ratings or rankings are also encompassed by the present invention.

All of the questions contained herein are exemplary. Similar questions are also encompassed by the present invention.

For ballots that cover a role or a career(s) at a company, the following may be specified:

an Aspirational Job and/or

a First Job which is along the career path of the Aspirational Job and/or

a Second Job which is along the career path of the Aspirational Job and the First Job

In a non-limiting embodiment, features and characteristic of the Aspirational Job are provided.

The second job typically requires more experience and pays a higher salary than the first job.

In a non-limiting embodiment of the invention, a company being explored, evaluated and ranked is a college. In this embodiment, the ballot and related methods of the invention can be used to help a User choose a college to attend. Herein, the terms “college” and “university” are used interchangeably. Various aspects of a college are explored, evaluated and ranked. Such aspects of a college and related rankings include, but are not limited, to the following: the Location of the college and related attributes; the Campus and campus life; Famous Graduates of the college; academic programs at the college including majors offered; intercollegiate and intramural Athletics; Other; etc.

Suitable, exemplary, non-limiting questions for ballots which involving rankings associated with one or more aspects of a college include the following:

CQ1: How far is the college from your home?

CQ2: What is the closest city or town to the university?

CQ3: Do you characterize the college as small, medium or large?

CQ4: How many gyms are on campus? What is the quality of gyms on campus?

CQ5: How many bars or restaurants are near campus?

CQ6: What public transportation is available on or near campus?

CQ7: Who are the university’s most famous graduates?

CQ8: Who is the most famous graduate of the college in your chosen field?

CQ9: Does the university have any graduates who are Rhode Scholars and other Award Winners?

CQ10: How many different majors does the college offer?

CQ11: What are the National rankings of majors that interest me at the college?

CQ12: Does the college have any Renowned Professors?

CQ13: What sports teams does the college have?

CQ14: What conference does the college’s basketball or football team play in?

CQ15: How many national champions in basketball or football or baseball has the college won?

CQ16: Does the university offer athletic scholarships?

CQ17: how many different student Clubs does the university have? And what are they?

CQ18: What are the demographics of the university?

CQ19: What percentage of students live on campus? Off campus?

CQ20: What percentage of students at the college work on campus?

CQ21: What intramural sports are available at the university?

CQ22: What percentage of students at the university receive financial aid?

CQ23: What unique scholarships does the university offer?

According to the method of the present invention, a User explores, evaluates, answers questions about and/or ranks various aspects of a company. The system implementing the method of the present invention accomplishes all of the steps necessary to interact with a User to provide a ballot sheet, provide questions and receive relevant rankings with any suitable questions and receive a ballot as well as record and store information like User rankings on a received ballot.

For the method of the present invention, the aspects of a company and associated rankings, the questions, etc. are as described above.

In a non-limiting embodiment, the invention is a method for completing a ballot comprising or comprising the steps of:
(a) providing a ballot sheet including an object with one or more sections;
(b) providing one or more questions; and
(c) providing instructions for how to translate a User answer(s) or ranking(s), a first User answer or ranking, into a color or colors in a section of said object.

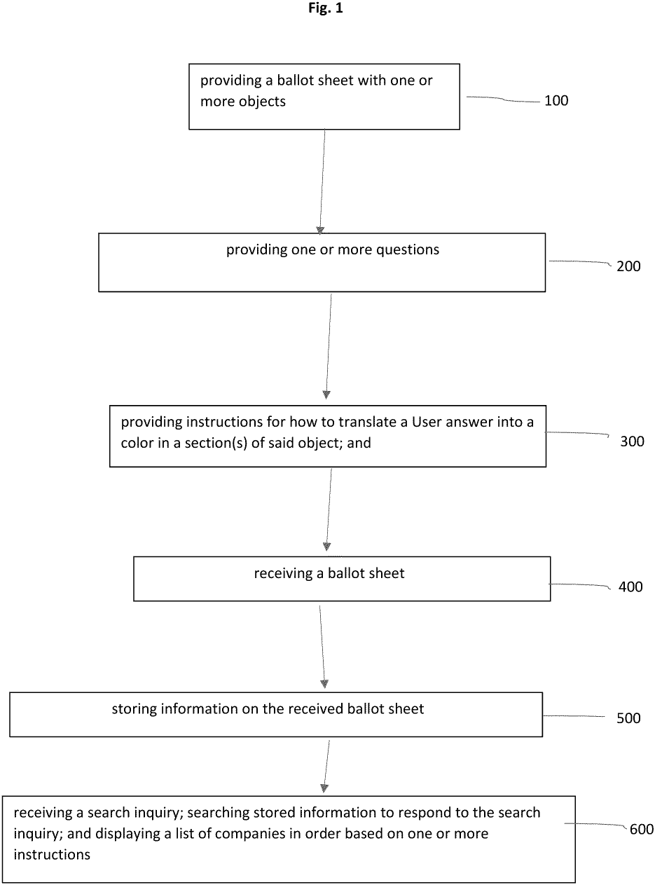

As shown in FIG. 1, the method of the present invention comprises the following steps.

Step 100 comprises providing a ballot sheet including at least one object. The object can include one or more sections. In a non-limiting embodiment, providing a ballot sheet can comprise presenting the ballot sheet on paper or similar to a User. In another non-limiting embodiment, providing a ballot sheet can comprise displaying the ballot sheet on a screen like a computer screen or similar. If the ballot sheet is displayed on a computer screen or similar, the ballot sheet can be completed via a computer or printed out and completed by hand.

This step can be accomplished by other means which are well known in the art.

Step 200 comprises providing one or more questions or aspects of a company to be ranked.

Said aspect(s) is associated with one or more User ranking(s). In a non-limiting embodiment, providing one or more aspects of a company comprises presenting such aspects on paper or similar to a User. In another non-limiting embodiment, providing one or more aspects of a company comprises displaying such aspects on a screen like a computer screen or similar. The aspects of a company and/or rankings can be printed out using a computer or similar.

As described above, there can be a first aspect of a company and a first User answer or ranking. As well as a second aspect of a company and second User answer or ranking. And a third aspect of a company and third answer or ranking and so on and so forth.

This step can be accomplished by other means which are well known in the art.

Step 300 comprises providing instructions for how to translate a User answer or ranking(s) into action on the ballot sheet.

In one non-limiting embodiment of the invention, the answer or ranking translates into a color(s) in a specific section of the object.

In one non-limiting embodiment of the invention, the answer or ranking translates into a doodle(s) on said ballot sheet. In a non-limiting embodiment, providing such instructions comprises presenting such on paper or similar to a User. In another non-limiting embodiment, providing such instructions comprises displaying such instructions on a screen like a computer screen or similar. The instructions can be printed out using a computer or similar.

As described above, there can be a first User answer or ranking and a first doodle having one or more characteristics. As well as a second User answer or ranking and a second doodle having one or more characteristics. And a third User answer or ranking and a third doodle having one or more characteristics and so on and so forth.

This step can be accomplished by other means which are well known in the art.

Step 400 comprises receiving a completed ballot sheet

In one non-limiting embodiment,

In another non-limiting embodiment, the ballot contains one or more colored sections of objections or objects.

In another non-limiting embodiment, the ballot contains one or more doodles. The ballot sheet with one or more doodles can be received in various ways. In a non-limiting embodiment, the ballot sheet can be scanned and emailed. In another non-limiting embodiment, a photograph of the ballot sheet with one or more doodles can be taken, and the ballot sheet submitted via Instagram or a similar application. In yet another non-limiting embodiment, the ballot sheet with one or more doodles can be completed on a computer and can be uploaded directly into the system of the present invention.

This step can be accomplished by other means which are well known in the art.

In a non-limiting embodiment, the method further comprise the step of storing the ranking and other information on the received ballot sheet for a company. This is Step 500 in FIG. 1.

In a non-limiting embodiment, the method can further comprise the step of displaying one or more company names associated with received ballots where the company names are listed in order based on one or more User rankings. This is Step 600 in FIG. 1.

In a non-limiting embodiment, the method can further comprise the steps of
receiving a search inquiry;
searching stored ballots including the User rankings thereon to respond to the search inquiry; and
displaying a list of companies in order based on one or more User ratings associated with a company.

According to the present invention, the method is accomplished via a computer system.

In a non-limiting embodiment of the invention, the method comprises completing and/or receiving multiple ballots. And a received ballot(s) can be stored on the system implementing the method of the invention.

The submitted User answers or rankings and other on a ballot(s) for a company or companies can be used for various purposes. For example, User answer or Ranking(s) and other information on received ballots associated with various companies can be used to compare companies and determine User preferences.

In a non-limiting embodiment, the method of the present invention comprises an additional step of determining a User preference(s) for company-centric decisions based on one or more User rankings included on received ballot(s) associated with various companies from a User which is stored in the system implementing the method.

Examples of User preferences for company-centric decisions include, but are not limited to, the following:
(a) a Preferred role or occupation(s) to pursue as a career;
(b) a Preferred industry or industries to work in;
(c) a Preferred company or companies to work at or for; etc.

The above User preferences for company-centric decisions can be used as search criteria and entered or selected by a User into a system used to implement the present invention.

The name of a company or companies can be displayed in a certain order in response to search criteria from the User, wherein said search term is entered into the system by a User.

In a non-limiting embodiment, the method of the present invention comprises an additional step of displaying a list of companies in a defined order based on User preference(s) for a company-centric decision(s) based on one or more User rankings received on a ballot(s) by a User.

The present inventions insures Users will have a compilation of her/his User ratings from received/submitted ballots covering various companies which can serve as an aid to help make company-centric and/or other decisions in the future.

The methods of the present invention described herein are carried out or implement on or by a computer or computer system including a mobile phone as is well known in the art. The system referred to herein can be any well known computer or type of computer system. Such computer system may utilize one or more of the popular social networks like Instagram, Facebook, etc.

The methods of the present invention described herein may also utilize one or more well known applications like Instagram or Facebook either solo or in conjunction with a computer or computer system or mobile phone.

The computer can include server computers, client computers, personal computers (PC), tablet PC, set-top boxes (STB), personal digital assistant devices (PDA), web appliances, network routers, switches or bridges, or any computing devices capable of executing instructions that specify actions to be taken by the computing devices. Some of the computers are coupled to each other via a local area network (LAN), which in turn is coupled to the Internet.

Also, each computer referred herein can include any collection of computing devices that individually or jointly execute instructions to provide one or more of the systems discussed herein, or to perform any one or more of the methodologies or functions discussed herein, or to act individually or jointly as one or more of a publisher, an advertiser, an advertisement agency, an ad middleman, an ad server, an ad exchange, etc. which employs the systems, methodologies, and functions discussed herein.

A computer that can be used to perform one or more of the methodologies and/or to provide one or more of the systems in an advertisement platform discussed herein, by executing certain instructions. The computer/server may operate as a standalone device or as a peer computing device in a peer-to-peer (or distributed) network computing environment.

The computer includes one or more processors (e.g., a central processing unit (CPU), a graphic processing unit (GPU), and/or a digital signal processor (DSP)) and a system or main memory coupled to each other via a system bus. The computer may further include static memory, a network interface device, a storage unit, one or more display devices, one or more input devices, and a signal generation device (e.g., a speaker), with which the processor(s) can communicate via the system bus.

In certain embodiments, the display device(s) include one or more graphics display units (e.g., a plasma display panel (PDP), a liquid crystal display (LCD), a projector, or a cathode ray tube (CRT)). The input device(s) may include an alphanumeric input device (e.g., a keyboard), a cursor control device (e.g., a mouse, trackball, joystick, motion sensor, or other pointing instrument). The storage unit includes a machine-readable medium on which is stored instructions (e.g., software) that enable anyone or more of the systems, methodologies or functions described herein. The storage unit may also store data used and/or generated by the systems, methodologies or functions. The instructions (e.g., software) may be loaded, completely or partially, within the main memory or within the processor (e.g., within a processor’s cache memory) during execution thereof by the computer/server. Thus, the main memory and the processor also constituting machine-readable media.

The computer or client device can include any appropriate electronic device operable to send and receive requests, messages, or other such information over an appropriate network and convey information back to a user of the device. Examples of such client devices include personal computers, tablet computers, smartphones, notebook computers, and the like.

A computer encompasses a portable computing device that includes a smartphone, an electronic book reader, or tablet computer, but it should be understood that any device capable of receiving and processing input can be used in accordance with various embodiments discussed herein. The devices can include, for example, desktop computers, notebook computers, electronic book readers, personal data assistants, cellular phones, video gaming consoles or controllers, television set top boxes, and portable media players, among others.

The computing device can also include at least one microphone or other audio capture elements capable of capturing audio data, such as words spoken by a user of the device, although audio elements are not required in at least some devices.

Through the method of the present invention, business knowledge is gained, key professional processes are honed, and important life skills are developed so Users can have more successful professional lives encompassing career success and success managing personal finances.

1. A ballot comprising:
(a) a ballot sheet; and
(b) at least one object, a first object on said ballot, a first doodle, in a section of the ballot sheet, wherein at least one characteristic of said first doodle is determined by a User ranking, a first User ranking, associated with an aspect of a company, a first aspect of a company, wherein the color of the object is determined by a User’s answer to one or more questions provided with the ballot.

2. A ballot according to claim 1 wherein said object has at least 2 sections.

3. A ballot according to claim 1 wherein said object is a famous work of art.

4. A ballot comprising: (a) a ballot sheet having one or more sections; and (b) at least one doodle, a first doodle, in a section of the ballot sheet, wherein at least one characteristic of the first doodle is determined by a User answer, a first User answer.

5. A ballot according to claim 4 wherein the ballot sheet has at least 4 sections.

6. A ballot according to claim 4 wherein sections in said ballot sheet are labeled.

7. A ballot according to claim 4 wherein the characteristic determined by the first User answer is the section of the ballot sheet the first doodle appears in, is placed in.

8. A ballot according to claim 4 wherein the characteristic determined by the first User answer is the shape of the first doodle.

9. A ballot according to claim 4 wherein the characteristic(s) determined by the first User answer is the location, color and/or the shape of the first doodle.

10. A ballot according to claim 4 comprising a second doodle, in at least one section of the ballot sheet, wherein a characteristic(s) of said second doodle is determined by a second User answer.

11. A ballot according to claim 4 comprising a third doodle, in at least one section of the ballot sheet, wherein a characteristic(s) of said third doodle is determined by a third User answer.

12. A ballot according to claim 8 wherein the first doodle a is 0.5 inch line and the color of the line is determined by the first User ranking.

13. A ballot according to claim 12 wherein the following applies:
if the User ranking is “1”, the color of the line is red;
if the User ranking is “2”, the color of the line is blue;
if the User ranking is “3”, the color of the line is green;
if the User ranking is “4”, the color of the line is yellow;
if the User ranking is “5”, the color of the line is purple; and
if the User ranking is “6”, the color of the line is black.

14. A ballot according to claim 1 wherein the ballot represents the thoughts and feelings of a User about a company.

15. A method for completing a ballot comprising:
(a) providing a ballot sheet including at least one object;
(b) providing at least one question to be answered, a first question;
(c) providing instructions for how to translate the answer to said first question into a characteristic of the object ; and
(d) receiving the ballot sheet.

16. A method according to claim 15 further comprising the step of storing information on the received ballot sheet for a company.

17. A method according to claim 15 accomplished via a computer system.

18. A method according to claim 15 further comprising the step of displaying one or more company names associated with a submitted ballot(s) where the company names are displayed in order based on one or more User rankings.

19. A method according to claim 15 further comprising the step of
receiving a search inquiry;
searching User rankings or other information from stored ballots to respond to the search inquiry; and
displaying a list of companies in order based on one or more User ratings associated with a company.
